(19) United States
(12) Patent Application Publication
(10) Pub. No.: US 2016/0047925 A1
(43) Pub. Date: Feb. 18, 2016

(54) Method of Determining Seismic Acquisition Aperture

(71) Applicants: Xiaoting Lou, Houston, TX (US); Philip Schultz, Houston, TX (US)

(72) Inventors: Xiaoting Lou, Houston, TX (US); Philip Schultz, Houston, TX (US)

(73) Assignee: Chevron U.S.A. Inc., San Ramon, CA (US)

(21) Appl. No.: 14/457,670

(22) Filed: Aug. 12, 2014

(51) Int. Cl. G01V 1/30; G01V 1/24

(52) U.S. Cl. CPC G01V 1/303; G01V 1/247; G01V 1/3843

(57) ABSTRACT

Embodiments of a method for determining a seismic acquisition aperture are disclosed herein. In general, embodiments of the method utilize ray tracing with simulation of dip angles with virtual convex surfaces. In particular, embodiments of the method use the placement of a plurality of spherical convex surfaces around a subterranean region or area of interest. Further details and advantages of various embodiments of the method are described in more detail below.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND

1. Field of the Invention

This invention relates generally to the field of geophysical exploration for hydrocarbons. More specifically, the invention relates to a method of determining seismic acquisition coverage.

2. BACKGROUND of the INVENTION

A seismic survey is a method of imaging the subsurface of the earth by delivering acoustic energy down into the subsurface and recording the signals reflected from the different rock layers below. The source of the acoustic energy typically comes from a seismic source such as without limitation, explosions or seismic vibrators on land, and air guns in marine environments. During a seismic survey, the seismic source may be moved across the surface of the earth above the geologic structure of interest. Each time a source is detonated or activated, it generates a seismic signal that travels downward through the earth, is reflected, and, upon its return, is recorded at different locations on the surface by receivers. The recordings or traces are then combined to create a profile of the subsurface that can extend for many miles. Referring to FIG. 1, in order to perform a 3D marine seismic survey, an array of seismic streamers, each typically several thousand meters long and potentially having arrays of seismic sensors (e.g. hydrophones) and associated electronic equipment distributed along its length, may be towed behind a seismic survey vessel 10, which also tows one or more seismic sources 13. Acoustic signals produced by the seismic sources are directed down through the water into the earth beneath and are reflected at interfaces where acoustic impedances of the differing geologic strata change. The reflected signals may be received by seismic sensors in the streamers or alternatively, may be received by many seismic sensors 15 placed on the seafloor (e.g. ocean bottom sensors (OBS)), digitized and then transmitted to the seismic survey vessel 10, where they are recorded and at least partially processed with the ultimate aim of building up a representation of the earth strata in the area being surveyed. A 3D survey produces a data “cube” or volume that theoretically represents a 3D picture of the subsurface that lies beneath the survey area.

In some instances, an initial seismic survey may not be sufficient to image the entire subterranean area or region of interest (AOI). As such, another seismic survey may be shot or purchased over the same AOI. In order to cost effectively acquire the seismic data (seismic surveys may run into the tens of millions of dollars), the placement of the nodes should be carefully determined in order to acquire the optimal coverage of seismic data (not too much and not too little). In geological areas where the topography of highly complex or rugose (e.g. dips, etc.), proper acquisition coverage may be difficult to estimate due to the reflection angles. Consequently, there is a need for methods and systems for determining seismic acquisition aperture.

### BRIEF SUMMARY

Embodiments of a method for determining a seismic acquisition aperture are disclosed herein. In general, embodiments of the method utilize ray tracing with simulation of dip angles with virtual convex surfaces. In particular, embodiments of the method use the placement of a plurality of spherical convex surfaces around a subterranean region or area of interest. Further details and advantages of various embodiments of the method are described in more detail below.

In an embodiment, a computer-implemented method of determining seismic acquisition coverage comprises: (a) selecting a subterranean region of interest, the subterranean region of interest having a perimeter. The method also comprises (b) inputting a velocity model derived from an existing seismic data set of the subterranean region of interest. In addition, the method comprises (c) selecting a horizon from the velocity model. The method further comprises (d) placing a plurality of convex spherical surfaces along the perimeter of the subterranean region of interest. The method additionally comprises (e) performing a ray tracing operation on the horizon and the plurality of convex spherical surfaces to create a simulated seismic output from a range of dips and (f) determining an optimum seismic aperture for seismic acquisition, the optimum seismic aperture based on the ray tracing operation, wherein at least one of (a) through (f) is performed on a computer.

In another embodiment, a computer system comprises an interface for receiving a seismic input volume, the seismic input volume comprising a plurality of seismic traces. The computer system further comprises a memory resource. In addition, the computer system comprises input and output functions for presenting and receiving communication signals to and from a human user. The computer system also comprises one or more central processing units for executing program instructions and program memory coupled to the central processing unit for storing a computer program including program instructions that when executed by the one or more central processing units, cause the computer system to perform a plurality of operations for determining a seismic acquisition aperture. The plurality of operations comprise: (a) selecting a subterranean region of interest, the subterranean region of interest having a perimeter. The operations also comprise (b) inputting a velocity model derived from an existing seismic data set of the subterranean region of interest. In addition, the operations comprise (c) selecting a horizon from the velocity model. The operations further comprise (d) placing a plurality of convex spherical surfaces along the perimeter of the subterranean region of interest. The operations additionally comprise (e) performing a ray tracing operation on the horizon and the plurality of convex spherical surfaces to create a simulated seismic output from a range of dips and (f) determining an optimum seismic aperture for seismic acquisition, the optimum seismic aperture based on the ray tracing operation, wherein at least one of (a) through (f) is performed on a computer.

In another embodiment, a computer-implemented method of determining a seismic acquisition aperture, the method comprises (a) generating a plurality of convex spherical surfaces. Furthermore, the method comprises (b) placing the plurality of convex spherical surfaces along a perimeter of a selected horizon from a subterranean region of interest. The method also comprises (c) performing a ray tracing operation on the horizon and the plurality of convex spherical surfaces to create a simulated seismic output from a range of dips; and (d) determining an optimum seismic aperture for seismic acquisition, the optimum seismic aperture based on the ray tracing operation, wherein at least one of (a) through (d) is performed on a computer.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a 3D schematic representation of a marine seismic acquisition along with seismic aperture which is the goal of the disclosed methods;

FIG. 2 illustrates an embodiment of a method for determining a seismic acquisition aperture;

FIG. 3A illustrates a 3D schematic of an embodiment of a method for determining a seismic acquisition aperture;

FIG. 3B illustrates the ray tracing operation during an embodiment of a method for determining a seismic acquisition aperture;

FIG. 3C shows the results of an embodiment of a method for determining a seismic acquisition aperture;

FIG. 4 shows examples of different convex spherical surfaces which may be used with embodiments of the method; and

FIG. 5 a schematic of a system which may be used in conjunction with embodiments of the disclosed methods.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to...”. Also, the term “couple” or “couples” is intended to mean either an indirect or direct connection. Thus, if a first device couples to a second device, that connection may be through a direct connection, or through an indirect connection via other devices and connections.

As used herein, “aperture” refers to the coverage area or window for placement of OBS or seismic sensors and sources so as to obtain an adequate seismic “image” beneath the surface of the earth.

As used herein, “ray tracing” refers to an operation for calculating the path of a seismic wave through a system with regions of varying propagation velocity, absorption characteristics, and reflecting surfaces such as the earth. The wavefronts may bend, change direction, or reflect off surfaces, complicating analysis. Ray tracing solves the problem by repeatedly advancing simulated or virtual narrow beams called “rays” through the earth medium by discrete amounts.

As used herein, “seismic trace” refers to the recorded data from a single seismic recorder or seismograph and typically plotted as a function of time or depth.

### DETAILED DESCRIPTION OF THE PREFERRED EMBODIMENTS

Referring now to the Figures, embodiments of the disclosed methods will be described. As a threshold matter, embodiments of the methods may be implemented in numerous ways, as will be described in more detail below, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the disclosed methods are discussed below. The appended drawings illustrate only typical embodiments of the disclosed methods and therefore are not to be considered limiting of its scope and breadth.

Embodiments of the disclosed methods assume a plurality of seismic traces have been acquired as a result of a seismic survey using any methods known to those of skill in the art. A seismic survey may be conducted over a particular geographic region whether it be in an onshore or offshore context. Although this disclosure will focus on the offshore context, embodiments of the method may be applied to onshore seismic acquisition as well. A survey may be a three dimensional (3D) or a two dimensional (2D) survey. The raw data collected from a seismic survey are unstacked (i.e., unsummed) seismic traces which contain digital information representative of the volume of the earth lying beneath the survey.

The goal of a seismic survey is to acquire a set of seismic traces over a subsurface target of some potential economic importance. Data that are suitable for analysis by the methods disclosed herein might consist of, for purposes of illustration only, a 2-D stacked seismic line extracted from a 3-D seismic survey or, a 3-D portion of a 3-D seismic survey. However, it is contemplated that any 3-D volume of seismic data might potentially be processed to advantage by the methods disclosed herein. Although the discussion that follows will be described in terms of traces contained within a 3-D survey, any assembled group of spatially related seismic traces could conceivably be used. After the seismic data are acquired, they are typically brought back to the processing center where some initial or preparatory processing steps are applied to them.

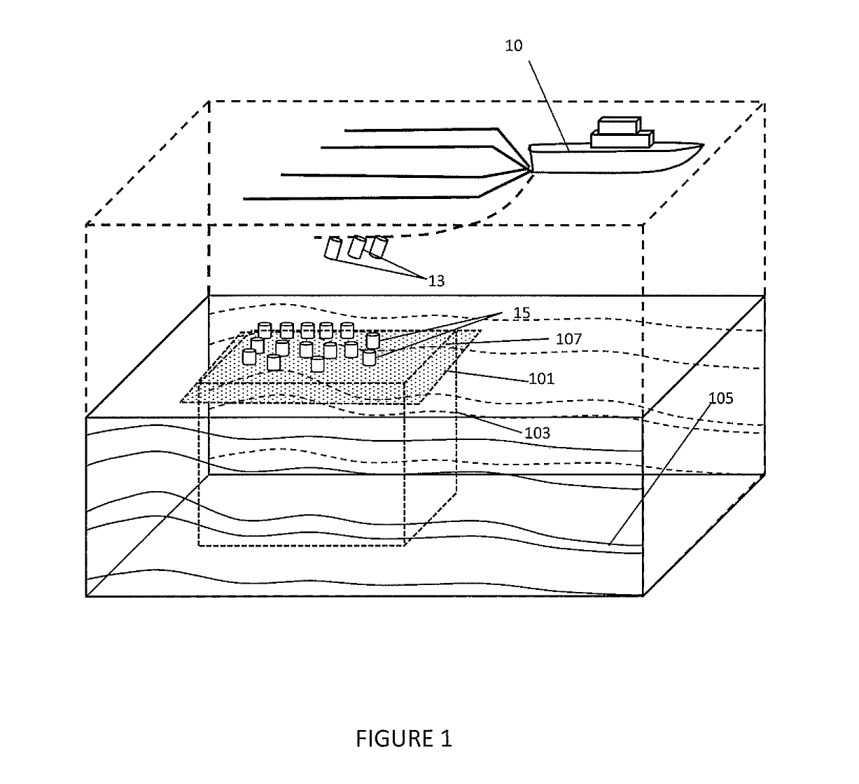

Standard seismic tomography methods include forward modeling to match synthetic data computed from an earth or subsurface model to real recorded data. This match is achieved by making incremental changes to the earth model to find the velocity model that minimizes the mismatch between the reflection-event traveltimes of modeled and recorded data. Referring to FIG. 1, subsurface or earth modeling for petroleum exploration or geological modeling often uses a layered velocity model consisting of layers 105 of time horizons and the zones between them. These depict the velocity at different depths and thus the travel time of seismic waves, acoustic or vibrational, artificially generated to “see” (i.e. to generate an image of) the structures and features of the underground.

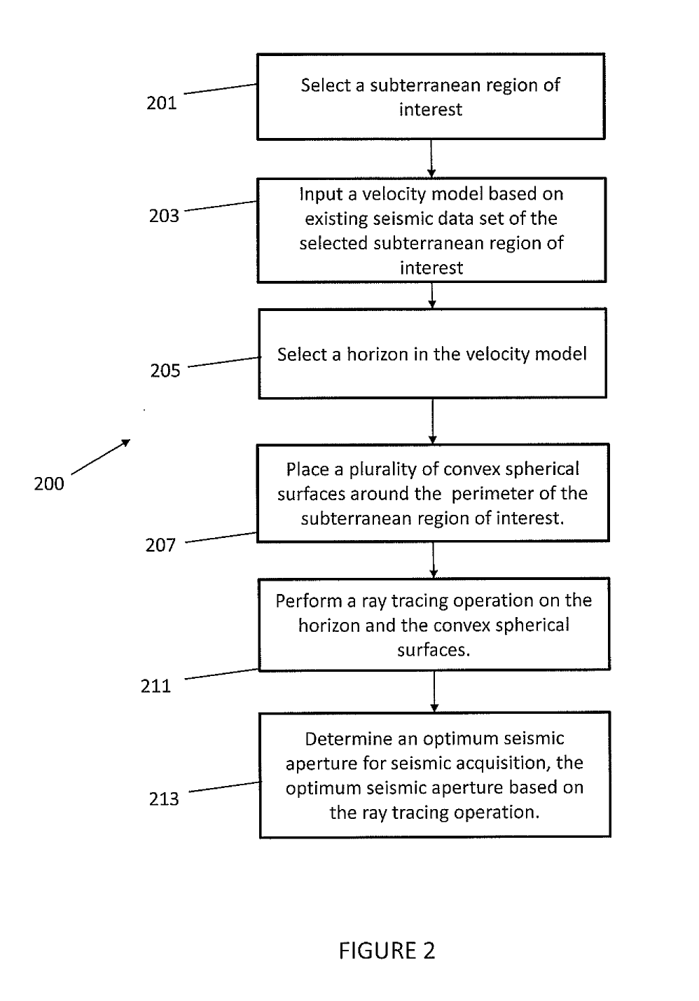

FIGS. 1 and 2 illustrate visually an embodiment of a method 200 and include a flow chart that illustrates an embodiment of the disclosed method, wherein a seismic aperture 101 is determined or optimized based upon the results of the disclosed method. The aperture 101, although shown illustratively as a square, that is determined may be of any shape and size depending on the results of the disclosed methods. Referring to FIG. 1, existing seismic data from a subsurface volume or subterranean region of interest 103 may be selected in 201. The subsurface region 103 may be a three dimensional volume or a two dimensional area of interest. A seismic velocity model of the subterranean regions or areas may be selected or generated in 203 through methods well known to those of skill in the art.

Referring to FIG. 2, the seismic velocity model may be input in 203 into any suitable geophysical interpretation software known to those in the art. Once input into the software, a surface or horizon 105 in the velocity model may be selected by the user in 205. As used herein, a surface or horizon refers to a specific or particular layer in the subterranean region or area of interest 103. In an embodiment, the user may then select a specific perimeter or area 107 of the selected horizon 105.

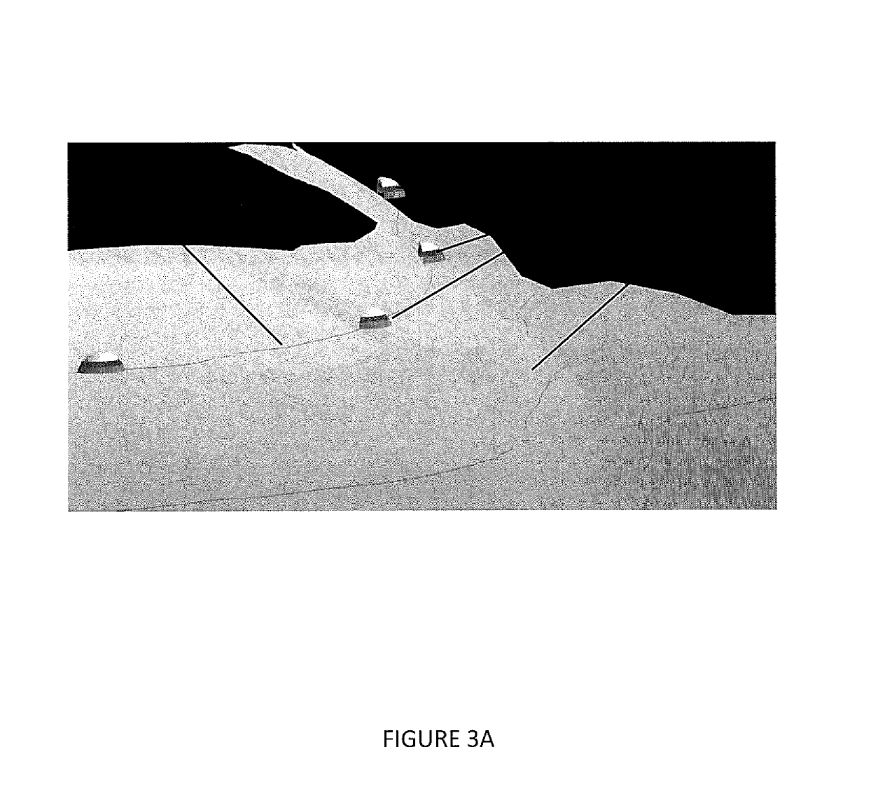

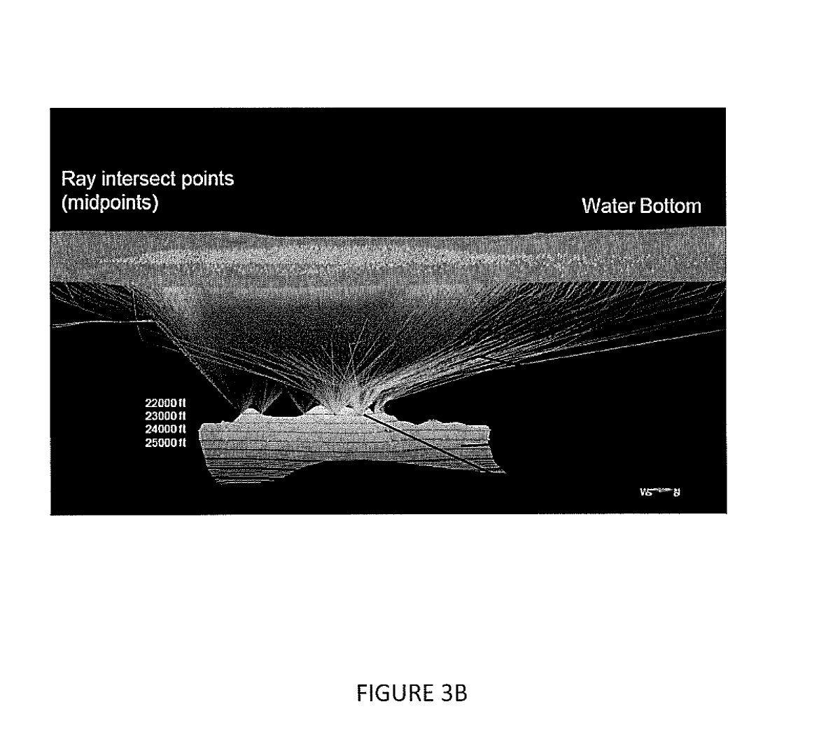

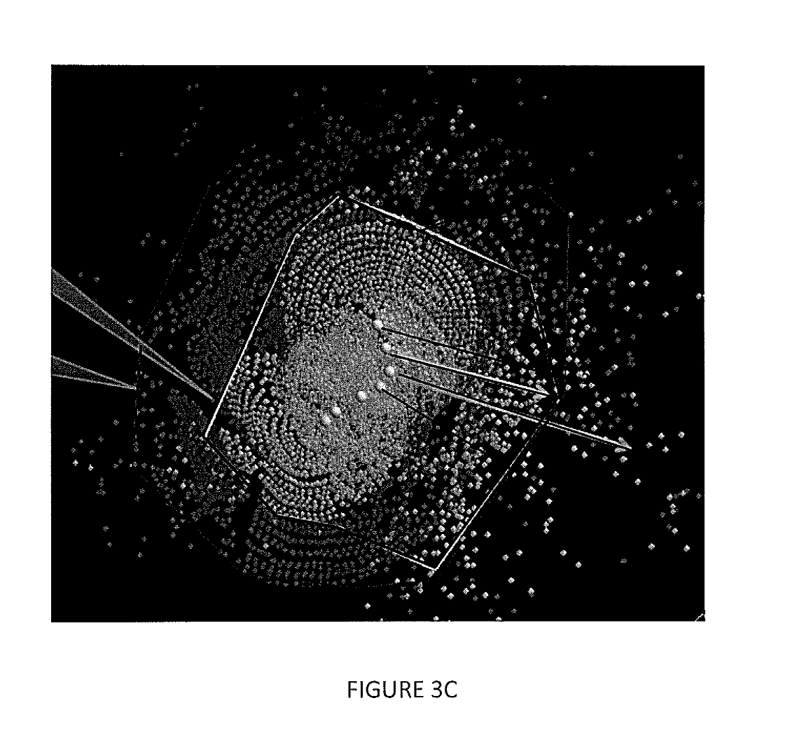

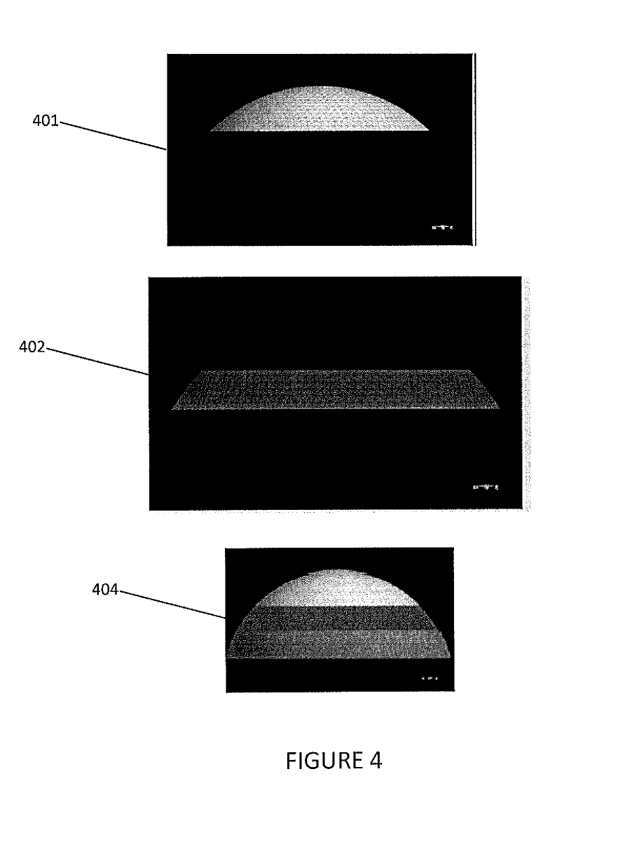

Now referring to FIGS. 3A and 4, a plurality of convex spherical surfaces 303 may be created or virtualized in a geophysical software package such as Paradigm GoCad. However, any suitable software package may be used. The surfaces may be approximate surfaces that are created using a mesh or through a triangulation grid. However, any methods may be used to create the convex surfaces. As used herein, the phrase “convex spherical surfaces” refers to any and all spherical or spherical-like geometries (e.g. ovoid) in the broadest sense. For example, referring to FIG. 4, convex spherical surfaces 303 includes without limitation, spherical segments (see 402), spherical wedges, spherical caps (see 401), spherical portions, hemispheres (see 404), truncated spheres, and the like. In addition, any number of convex spherical surfaces may be utilized in embodiments of the methods. For illustrative purposes, FIG. 3A depicts the use of 4 convex spherical surfaces.

As shown in FIG. 3A, each convex spherical surface may be placed in any position at the same depth on the selected horizon 301. In an embodiment, the surfaces 303 are placed around the perimeter of the area or region of interest in 205. The convex spherical surfaces 303 may be equidistant from each other or may be all different distances from each other.

In an embodiment, a plurality of parameters may be input into the software which define the characteristics and placement of the plurality of convex spherical surfaces 303. In particular, parameters such as without limitation, the type of convex spherical surface 303 (e.g. spherical cap, spherical segment, etc.), the geometrical or geographical coordinates which define the locus or center of each convex spherical surface, the range of dip angles to be simulated (i.e. the largest perimeter of each convex spherical surface), the azimuth of each convex spherical surface. Each of these parameters will be described in more detail below. Other suitable parameters may be input which may be known to those of skill in the art.

With respect to the geometrical or geographical coordinates which define the locus or center of each convex spherical surface, the center coordinates may be equidistant from each surface, automatically calculated, or selected by the user. The dip angle parameter as mentioned above is the largest dip angle for which the convex spherical surface will simulate. In other words, for a spherical cap type of convex surface, if the perimeter is larger, than a steeper or larger range of dip angles will be formed as shown in FIG. 4. Likewise, the smaller the dip angle, the smaller the perimeter of the spherical cap. A dip angle range parameter may also be defined. For a spherical cap, the range of dip angles may be 0 degrees to 60 degrees, for example. For a spherical segment, the range of dip angles may be any number range between 0 degrees and 180 degrees.

The azimuth parameter may define if a complete or only a portion of the convex spherical surface is used. That is, in an embodiment where a spherical cap is used, the entire spherical cap may be used, or in some embodiments, a half spherical cap as shown in FIG. 3A or a quarter of the spherical cap may be used. Any portion of a spherical cap or a spherical segment may be used. In an embodiment, the convex spherical surface 303 is aligned with a depth contour 305 on the selected horizon 301 surrounding the perimeter of the region of interest. However, the convex spherical surfaces 303 may be disposed in any suitable position around the region of interest on a selected horizon 301.

Once the plurality of convex spherical surfaces 303 have been created and placed appropriately in 207, a ray tracing operation may be performed in 211 with a range of dip angles depending on the geometry of the convex spherical surfaces selected. Ray tracing simulations or operations are known in the art. For example, a thorough description may be found in \check{C}ervený, V., L. Klime\check{s}, and I. P\check{s}en\check{c}ík. “Complete seismic-ray tracing in three-dimensional structures.” Seismological algorithms (1988): 89-168, which is incorporated herein by reference in its entirety for all purposes. FIG. 3B shows an illustrative schematic of what the ray tracing operation does in combination with the virtual convex surfaces 303. Without being limited to theory, the simulated rays 307 are reflected off the convex spherical surfaces 303 and back to the seafloor to provide an approximation of where seismic waves may be reflected back. FIG. 3C shows the results of the ray tracing operation. The white solid line shows the approximate aperture with a dip angle of 45 degrees, the dotted line shows a dip angle of 60 degrees.

In further embodiments, referring to 205 through 213 in FIG. 2, 207 through 213 may be repeated at different depths. That is the plurality of convex spherical surfaces may be placed at a different depth on the same horizon 301 and then the ray tracing operation may be performed. In other embodiments, the convex spherical surfaces may be placed in different locations at different depths and then the ray tracing operation may be performed. In another embodiment, another horizon 301 may be selected and 207 and 213 may be repeated.

Those skilled in the art will appreciate that the disclosed methods may be practiced using any one or combination of hardware and software configurations, including but not limited to a system having single and/or multi-processer computer processors system, hand-held devices, programmable consumer electronics, mini-computers, mainframe computers, supercomputers, and the like. The disclosed methods may also be practiced in distributed computing environments where tasks are performed by servers or other processing devices that are linked through one or more data communications networks. In a distributed computing environment, program modules may be located in both local and remote computer storage media including memory storage devices.

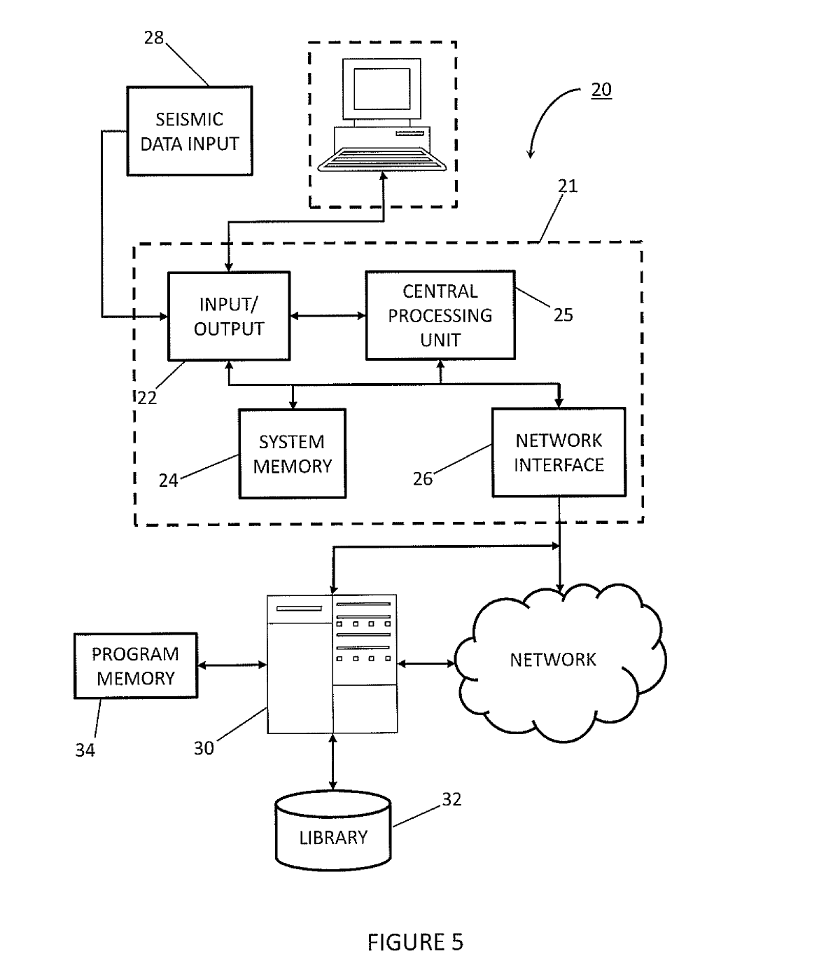

FIG. 5 illustrates, according to an example of an embodiment computer system 20, which may perform the seismic aperture determination or optimization operations described in this specification. In this example, system 20 is as realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 5 is provided merely by way of example.

As shown in FIG. 5 and as mentioned above, system 20 may include workstation 21 and server 30. Workstation 21 includes central processing unit 25, coupled to system bus. Also coupled to system bus BUS is input/output interface 22, which refers to those interface resources by way of which peripheral functions P (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by computer system. In the architecture of allocation system 20 according to this example, system memory 24 is coupled to system bus BUS, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 may implement such data memory and program memory in separate physical memory resources, or distributed in whole or in part outside of workstation 21. In addition, as shown in FIG. 3, seismic data inputs 28 that are acquired from a seismic survey are input via input/output function 22, and stored in a memory resource accessible to workstation 21, either locally or via network interface 26.

Network interface 26 of workstation 21 is a conventional interface or adapter by way of which workstation 21 accesses network resources on a network. As shown in FIG. 3, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment of the invention, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by allocation system 30. In this embodiment of the invention, these computer program instructions are executed by server 30, for example in the form of a “web-based” application, upon input data communicated from workstation 21, to create output data and results that are communicated to workstation 21 for display or output by peripherals P in a form useful to the human user of workstation 21. In addition, library 32 is also available to server 30 (and perhaps workstation 21 over the local area or wide area network), and stores such archival or reference information as may be useful in allocation system 20. Library 32 may reside on another local area network, or alternatively be accessible via the Internet or some other wide area network. It is contemplated that library 32 may also be accessible to other associated computers in the overall network.

The particular memory resource or location at which the measurements, library 32, and program memory 34 physically reside can be implemented in various locations accessible to allocation system 20. For example, these data and program instructions may be stored in local memory resources within workstation 21, within server 30, or in network-accessible memory resources to these functions. In addition, each of these data and program memory resources can itself be distributed among multiple locations. It is contemplated that those skilled in the art will be readily able to implement the storage and retrieval of the applicable measurements, models, and other information useful in connection with this embodiment of the invention, in a suitable manner for each particular application.

According to this embodiment, by way of example, system memory 24 and program memory 34 store computer instructions executable by central processing unit 25 and server 30, respectively, to carry out the disclosed operations described in this specification, for example, by way of which the elongate area may be aligned and also the stacking of the traces within the elongate area. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Such computer-executable instructions may include programs, routines, objects, components, data structures, and computer software technologies that can be used to perform particular tasks and process abstract data types. It will be appreciated that the scope and underlying principles of the disclosed methods are not limited to any particular computer software technology. For example, an executable web-based application can reside at program memory 34, accessible to server 30 and client computer systems such as workstation 21, receive inputs from the client system in the form of a spreadsheet, execute algorithms modules at a web server, and provide output to the client system in some convenient display or printed form. It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by allocation system 20 in the conventional manner for software installation.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A computer-implemented method of determining seismic acquisition coverage, the method comprising:
(a) selecting a subterranean region of interest, the subterranean region of interest having a perimeter;
(b) inputting a velocity model derived from an existing seismic data set of the subterranean region of interest;
(c) selecting a horizon from the velocity model;
(d) placing a plurality of convex spherical surfaces along the perimeter of the subterranean region of interest;
(e) performing a ray tracing operation on the horizon and the plurality of convex spherical surfaces to create a simulated seismic output from a range of dips; and
(f) determining an optimum seismic aperture for seismic acquisition, the optimum seismic aperture based on the ray tracing operation, wherein at least one of (a) through (f) is performed on a computer.

2. The method of claim 1 further comprising generating a plurality of convex spherical surfaces.

3. The method of claim 2 further comprising inputting one or more parameters to define the plurality of convex spherical surfaces.

4. The method of claim 3 wherein the one or more parameters comprises a maximum dip angle, a dip angle range, a set of coordinates which define each center of the plurality of convex spherical surface, or combinations thereof.

5. The method of claim 1 wherein the plurality of convex spherical surfaces comprises spherical caps, spherical segments, spherical segment portions, spherical cap portions, hemispheres, hemispherical portions, truncated spheres, or combinations thereof.

6. The method of claim 5 wherein the dip angle range ranges from about 0 degrees to about 180 degrees.

7. The method of claim 1 further comprising repeating (d) through (f) for a plurality of different depths.

8. The method of claim 1 further comprising repeating (c) through (f) for a plurality of different horizons.

9. A computer system, comprising:
an interface for receiving a seismic input volume, the seismic input volume comprising a plurality of seismic traces;
a memory resource;
input and output functions for presenting and receiving communication signals to and from a human user;
one or more central processing units for executing program instructions; and program memory, coupled to the central processing unit, for storing a computer program including program instructions that, when executed by the one or more central processing units, cause the computer system to perform a plurality of operations for determining a seismic acquisition aperture, the plurality of operations comprising:
(a) selecting a subterranean region of interest, the subterranean region of interest having a perimeter;
(b) inputting a velocity model derived from an existing seismic data set of the subterranean region of interest;
(c) selecting a horizon from the velocity model;
(d) placing a plurality of convex spherical surfaces along the perimeter of the region of interest;
(e) performing a ray tracing operation on the horizon and the plurality of convex spherical surfaces to create a simulated seismic output from a range of dips; and
(f) determining an optimum seismic aperture for seismic acquisition, the optimum seismic aperture based on the ray tracing operation.

10. The system of claim 9, wherein the operations further comprise generating a plurality of convex spherical surfaces.

11. The method of claim 10, wherein the operations further comprise inputting one or more parameters to define the plurality of convex spherical surfaces.

12. The method of claim 11 wherein the one or more parameters comprises a maximum dip angle, a dip angle range, a set of coordinates which define each center of the plurality of convex spherical surface, or combinations thereof.

13. The method of claim 9 wherein the plurality of convex spherical surfaces comprises spherical caps, spherical segments, spherical segment portions, spherical cap portions, truncated spheres, hemispheres, hemispherical portions, or combinations thereof.

14. The method of claim 13 wherein the dip angle range ranges from about 0 degrees to about 180 degrees.

15. The method of claim 9 wherein the operations further comprise repeating (d) through (f) for a plurality of different depths.

16. The method of claim 9 wherein the operations further comprise repeating (c) through (f) for a plurality of different horizons.

17. A computer-implemented method of determining a seismic acquisition aperture, the method comprising:
(a) generating a plurality of convex spherical surfaces;
(b) placing the plurality of convex spherical surfaces along a perimeter of a selected horizon from a subterranean region of interest;
(c) performing a ray tracing operation on the horizon and the plurality of convex spherical surfaces to create a simulated seismic output from a range of dips; and
(d) determining an optimum seismic aperture for seismic acquisition, the optimum seismic aperture based on the ray tracing operation, wherein at least one of (a) through (d) is performed on a computer.

18. The method of claim 17 wherein the plurality of convex spherical surfaces comprises spherical caps, spherical segments, spherical segment portions, spherical cap portions, hemispheres, hemispherical portions, truncated spheres, or combinations thereof.

19. The method of claim 17 further comprising inputting one or more parameters to define the plurality of convex spherical surfaces.

20. The method of claim 19 wherein the one or more parameters comprises a maximum dip angle, a dip angle range, a set of coordinates which define each center of the plurality of convex spherical surface, or combinations thereof.
